(19) United States
(12) Patent Application Publication
(10) Pub. No.: US 2021/0384744 A1
(43) Pub. Date: Dec. 9, 2021

(54) Electronic Device Storage Assembly

(71) Applicant: Heather Johnson, Grande Prairie (CA)

(72) Inventor: Heather Johnson, Grande Prairie (CA)

(21) Appl. No.: 16/891,447

(22) Filed: Jun. 3, 2020

(51) Int. Cl. H02J 7/00; A45C 11/00; A45C 13/00; A45C 15/00; A45C 13/02

(52) U.S. Cl. CPC H02J 7/0044; A45C 11/00; A45C 13/005; A45C 2013/025; A45C 13/02; A45C 2011/002; A45C 15/00

(57) ABSTRACT

An electronic device storage assembly for isolating and charging a communication enabled electronic device includes a box that defines an interior space. The box has a top, which open so that an electronic device can be inserted into the interior space. A lid is hingedly engaged to the box and is positioned to be selectively hinged to a closed configuration, wherein the lid closes the top. A sheet, which is engaged to an inner surface of the lid and an interior surface of the box, blocks radio waves and microwaves from entering into, and exiting from, the interior space. The sheet thus blocks transmissions to and from the electronic device positioned in the interior space. A charging module, which is engaged to the box and positioned in the interior space, is engageable to the electronic device to charge the electronic device.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to storage assembly and more particularly pertains to a new storage assembly for isolating and charging a communication enabled electronic device.

### (2) Description of Related Art Including Information Disclosed Under 37 CFR 1.97 and 1.98

The prior art relates to storage assembly. Prior art storage assemblies for communication enabled electronic devices may comprise cases, cabinets, and lock boxes to hold and charge one or more of the devices. Prior art storage assemblies also may comprise boxes that block the sending and receiving of radio signals.

### BRIEF SUMMARY OF THE INVENTION

An embodiment of the disclosure meets the needs presented above by generally comprising a box that defines an interior space. The box has a top, which open and thus configured for insertion of an electronic device into the interior space. A lid is hingedly engaged to the box and is positioned to be selectively hinged to a closed configuration, wherein the lid closes the top. A sheet, which is engaged to an inner surface of the lid and an interior surface of the box, is configured to block radio waves and microwaves from entering into, and exiting from, the interior space. The sheet is configured to block transmissions to and from the electronic device positioned in the interior space. A charging module, which is engaged to the box and positioned in the interior space, is configured to be engageable to the electronic device to charge the electronic device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a closed isometric perspective view of an electronic device storage assembly according to an embodiment of the disclosure.

FIG. 2 is an open isometric perspective view of an embodiment of the disclosure.

FIG. 3 is a cross-sectional view of an embodiment of the disclosure.

FIG. 4 is a top view of an embodiment of the disclosure.

### DETAILED DESCRIPTION OF THE INVENTION

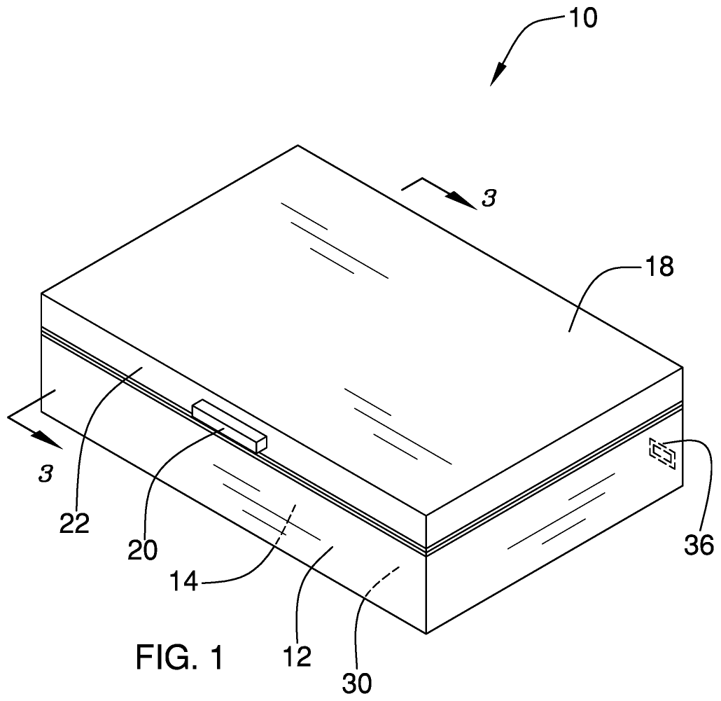

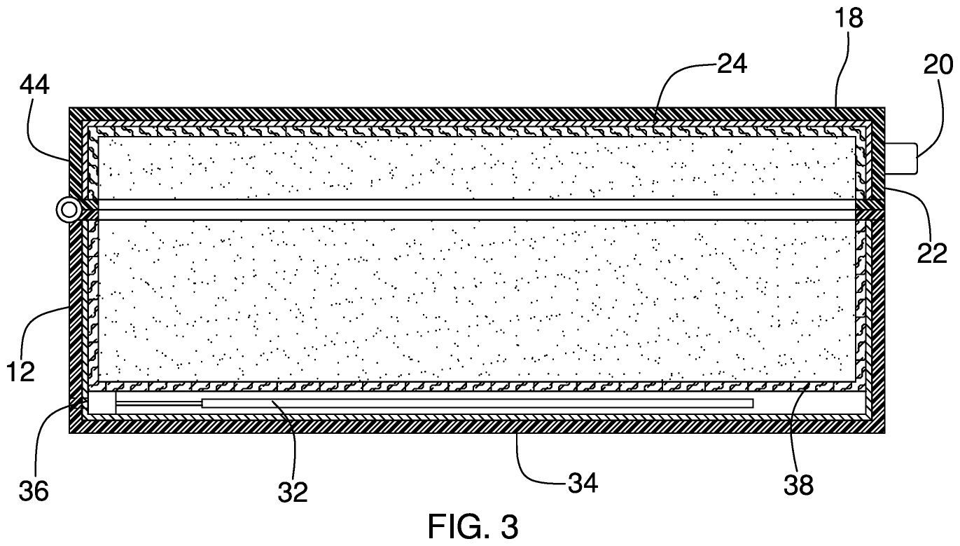

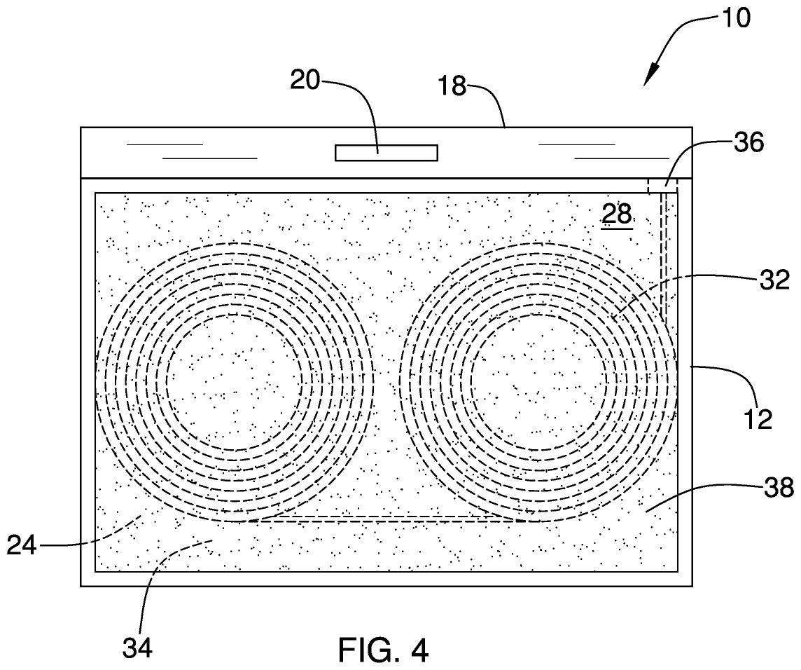

With reference now to the drawings, and in particular to FIGS. 1 through 4 thereof, a new storage assembly embodying the principles and concepts of an embodiment of the disclosure and generally designated by the reference numeral 10 will be described.

As best illustrated in FIGS. 1 through 4, the electronic device storage assembly 10 generally a box 12 that defines an interior space 14. The box 12 has a top 16, which is open and thus configured for insertion of an electronic device into the interior space 14.

A lid 18 is hingedly engaged to the box 12 and is positioned to be selectively hinged to a closed configuration wherein the lid 18 closes the top 16. A tab 20 is engaged to a front edge 22 of the lid 18. The tab 20 is configured to position a digit of a hand of a user so that the user is positioned to hinge the lid 18 relative to the box 12.

A sheet 24, which is engaged to an inner surface 26 of the lid 18 and an interior surface 28 of the box 12, is configured to block radio waves and microwaves from entering into, and exiting from, the interior space 14. The sheet 24 is configured to block transmissions to and from the electronic device positioned in the interior space 14. The sheet 24 comprises at least one of metal foil and metal foam.

The present invention is anticipated to be useful in a variety of settings. For example, a family may elect to use the electronic device storage assembly 10 to stow cell phones during mealtime to promote interaction among family members. The present invention also could be used in conference rooms, doctors' offices, and other settings where interruptions are disruptive.

A charging module 30, which is engaged to the box 12 and positioned in the interior space 14, is configured to be engageable to the electronic device to charge the electronic device. The charging module 30 may comprise an inductive coil 32, which is engaged to a bottom 34 of the box 12. The inductive coil 32 is configured to wirelessly charge the electronic device. The charging module 30 also may comprise other charging means, such as, but not limited to, charging ports, batteries, and the like.

A port 36 is engaged to the box 12 and is operationally engaged to the charging module 30. The port 36 is configured to selectively engage a power cord (not shown) to operationally engage the charging module 30 to a source of electrical current.

A liner 38 is positioned in the interior space 14 and is engaged to the sheet 24 so that the charging module 30 is positioned between the liner 38 and the sheet 24. The liner 38 is configured to pad the interior surface 28 of the box 12 and the charging module 30, thus protecting the electronic device. The liner 38 comprises at least one of felt, elastomeric foam, rubber, silicone, and cloth.

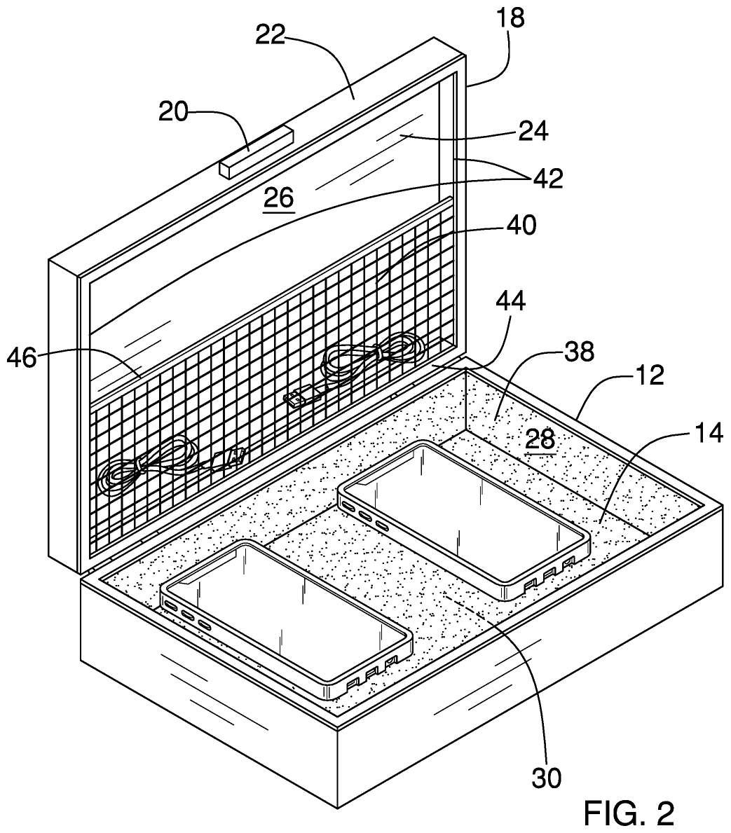

A panel 40 is engaged to and extends between opposed edges 42 of the lid 18. The panel 40 also is engaged to a rear edge 44 of the lid 18 so that the panel 40 and the inner surface 26 of the lid 18 define a pocket 46. The pocket 46 is configured to stow articles, such as charging cords for the electronic device positioned in the box 12, as shown in FIG. 2. The panel 40 is resiliently flexible and may comprise elastomer, or other resiliently flexible material, such as, but not limited to, rubber, silicone, and the like. The panel 40 also may be meshed, as shown in FIG. 2.

In use, the electronic device is positioned in the interior space 14 and the lid 18 is closed. The sheet 24 prevents transmissions to and from the electronic device, while the induction coil charges the electronic device.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. An electronic device storage assembly comprising:
a box defining an interior space, the box having a top, the top being open wherein the top is configured for insertion of an electronic device into the interior space;
a lid hingedly engaged to the box such that the lid is positioned for selectively hinging to a closed configuration wherein the lid closes the top;
a sheet engaged to an inner surface of the lid and an interior surface of the box, the sheet being configured for blocking radio waves and microwaves from entering into and exiting from the interior space, wherein the sheet is configured for blocking transmissions to and from an electronic device positioned in the interior space; and
a charging module engaged to the box and positioned in the interior space, the charging module being configured to be engageable to the electronic device for charging the electronic device.

2. The electronic device storage assembly of claim 1, further including a tab engaged to a front edge of the lid, wherein the tab is configured for positioning a digit of a hand of a user, positioning the user to hinge the lid relative to the box.

3. The electronic device storage assembly of claim 2, wherein the sheet comprises at least one of metal foil and metal foam.

4. The electronic device storage assembly of claim 1, wherein the charging module comprises an inductive coil engaged to a bottom of the box, wherein the inductive coil is configured for wirelessly charging the electronic device.

5. The electronic device storage assembly of claim 1, further including a port engaged to the box and being operationally engaged to the charging module, wherein the port is configured for selectively engaging a power cord for operationally engaging the charging module to a source of electrical current.

6. The electronic device storage assembly of claim 1, further including a liner positioned in the interior space and engaged to the sheet, such that the charging module is positioned between the liner and the sheet, wherein the liner is configured for padding the interior surface of the box and the charging module.

7. The electronic device storage assembly of claim 6, wherein the liner comprises at least one of felt, elastomeric foam, rubber, silicone, and cloth.

8. The electronic device storage assembly of claim 1, further including a panel engaged to and extending between opposed edges of the lid, the panel being engaged to a rear edge of the lid such that the panel and the inner surface of the lid define a pocket, wherein the pocket is configured for stowing articles.

9. The electronic device storage assembly of claim 8, wherein the panel is resiliently flexible.

10. The electronic device storage assembly of claim 9, wherein the panel comprises elastomer.

11. The electronic device storage assembly of claim 8, wherein the panel is meshed.

12. An electronic device storage assembly comprising:
a box defining an interior space, the box having a top, the top being open wherein the top is configured for insertion of an electronic device into the interior space;
a lid hingedly engaged to the box such that the lid is positioned for selectively hinging to a closed configuration wherein the lid closes the top;
a tab engaged to a front edge of the lid, wherein the tab is configured for positioning a digit of a hand of a user, positioning the user to hinge the lid relative to the box;
a sheet engaged to an inner surface of the lid and an interior surface of the box, the sheet being configured for blocking radio waves and microwaves from entering into and exiting from the interior space, wherein the sheet is configured for blocking transmissions to and from an electronic device positioned in the interior space, the sheet comprising at least one of metal foil and metal foam;
a charging module engaged to the box and positioned in the interior space, the charging module being configured to be engageable to the electronic device for charging the electronic device, the charging module comprising an inductive coil engaged to a bottom of the box, wherein the inductive coil is configured for wirelessly charging the electronic device;
a port engaged to the box and being operationally engaged to the charging module, wherein the port is configured for selectively engaging a power cord for operationally engaging the charging module to a source of electrical current;
a liner positioned in the interior space and engaged to the sheet, such that the charging module is positioned between the liner and the sheet, wherein the liner is configured for padding the interior surface of the box and the charging module, the liner comprising at least one of felt, elastomeric foam, rubber, silicone, and cloth; and
a panel engaged to and extending between opposed edges of the lid, the panel being engaged to a rear edge of the lid such that the panel and the inner surface of the lid define a pocket, wherein the pocket is configured for stowing articles, the panel being resiliently flexible, the panel comprising elastomer, the panel being meshed.
